(19) United States
(12) Patent Application Publication
(10) Pub. No.: US 2026/0185389 A1
(43) Pub. Date: Jul. 2, 2026

(54) MULTIFUNCTIONAL HINGES FOR VEHICLE CLOSURES

(71) Applicant: Rivian IP Holdings, LLC, Irvine, CA (US)

(72) Inventors: Bryan Scott SHAMASKO, Irvine, CA (US); Ajay Kumar PULLURI, Irvine, CA (US)

(21) Appl. No.: 19/002,461

(22) Filed: Dec. 26, 2024

(51) Int. Cl. E05D 3/04; E05D 5/02; E05F 15/60

(52) U.S. Cl. CPC E05D 3/04; E05F 15/60; E05D 5/0207; E05Y 2900/546; E05Y 2900/55

(57) ABSTRACT

A hinge assembly and a strut function to move one or more closures of a vehicle. The hinge assembly and the strut are positioned on the vehicle to balance the weight of each closure so as to limit the number of actuating mechanisms needed to open and close the closures. Also, the hinge assembly and the strut may open or close one closure relative to another closure. Alternatively, the hinge assembly and the strut may open or close both closures together.

### INTRODUCTION

This application is directed to closures of vehicles, and more particularly, to hinges that allow movement of multiple closures. Hinges described herein may be coupled with both a glass substrate and a liftgate, while allowing independent movement of the glass substrate.

### SUMMARY

An apparatus, which may include a hinge assembly, may couple with a vehicle body and multiple closures (e.g., transparent glass, liftgate), allowing for movement of one or both closures. Vehicles described herein may include one or more hinge assemblies and one or more struts, both of which function to facilitate movement of the closures.

In some aspects of the present disclosure, an apparatus is described. The apparatus may include a hinge assembly. The hinge assembly may include a first hinge component configured to couple with a first rear closure of a vehicle and rotate the first rear closure about an axis of rotation. The hinge assembly may further include a second hinge component configured to couple with a second rear closure of the vehicle and rotate the second rear closure about the axis of rotation.

The hinge assembly may further include a base configured to couple with the vehicle. The first hinge component may be configured to couple with the base, and may be configured to rotate the first rear closure about the axis of rotation. The second hinge component may be configured to couple with the base, and may be configured to rotate the second rear closure about the axis of rotation. The first hinge component may be configured to rotate independently of the second hinge component, and the second hinge component may be configured to rotate independently of the first hinge component.

The hinge assembly may further include a bar rotationally coupled with the base. The bar may be configured to pass through the first hinge component and the second hinge component. The bar may define the axis of rotation.

The apparatus may further include a latch configured to couple the first rear closure with the second rear closure. In response to the latch coupling the first rear closure with the second rear closure, the first hinge component may be configured to rotate the first rear closure about the axis of rotation while the second hinge component rotates the second rear closure about the axis of rotation. In response to the latch not coupling the first rear closure with the second rear closure, the hinge assembly is configured to rotate the first rear closure, relative to the second rear closure, about the axis of rotation.

The apparatus may further include a strut coupled with the first rear closure. The strut may be configured to provide a force to rotate the first rear closure about the axis of rotation. The strut may further be configured to provide the force to rotate the second rear closure about the axis of rotation.

In another aspect of the present disclosure, a vehicle is described. The vehicle may include a vehicle body. The vehicle may further include a first rear closure. The vehicle may further include a second rear closure. The vehicle may further include a hinge assembly coupled with the vehicle body. The hinge assembly may include a first hinge assembly coupled with the first rear closure. The hinge assembly may further include a second hinge assembly coupled with the second rear closure. The vehicle may further include a latch. In response to the latch coupling the first rear closure with the second rear closure, i) the first hinge assembly is configured to rotate the first rear closure about an axis of rotation and ii) the second hinge assembly is configured to rotate the second rear closure about the axis of rotation. In response to the latch not coupling the first rear closure with the second rear closure, the first hinge component is configured to rotate the first rear closure about the axis of rotation relative to the second rear closure.

The hinge assembly may further include a base coupled with the vehicle body. The first hinge component may be configured to couple with the base, and may be configured to rotate the first rear closure about the axis of rotation. The second hinge component may be configured to couple with the base, and may be configured to rotate the second rear closure about the axis of rotation. The first hinge component may be configured to rotate independently of the second hinge component, and the second hinge component may be configured to rotate independently of the first hinge component.

The hinge assembly may further include a bar rotationally coupled with the base. The bar may pass through the first hinge component and the second hinge component. The bar may define the axis of rotation.

The vehicle may further include a strut. The strut may include a first end coupled with the vehicle body. The strut may further include a second end opposite the first end. The second end may couple with the first rear closure. The first rear closure may include a transparent substrate, and the second rear closure may include a liftgate. The hinge assembly and the strut may be configured to balance i) a first mass defined by the first rear closure and ii) a second mass defined by the first rear closure and the second rear closure.

In yet another aspect of the present disclosure, hinge assembly is described. The hinge assembly may include a base. The base may include a first extension, a second extension, and a third extension positioned between the first extension and the second extension. The hinge assembly may further include a first hinge component positioned between the first extension and the third extension. The first hinge component may be configured to couple with a first rear closure of a vehicle about an axis of rotation. The hinge assembly may further include a second hinge component positioned between the second extension and the third extension. The second hinge component may be configured to couple with a second rear closure of the vehicle about the axis of rotation. The hinge assembly may further include a bar coupled with the base and passing through the first hinge component and the second hinge component. The first hinge component may be configured to rotate independently of the second hinge component, and the second hinge component may be configured to rotate independently of the first hinge component.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a vehicle, in accordance with aspects of the present disclosure.

FIG. 2 illustrates a rear view of a vehicle, in accordance with aspects of the present disclosure.

FIG. 3 illustrates a rear perspective view of a vehicle, showing a closure of the vehicle in an open position, in accordance with aspects of the present disclosure.

FIG. 4 illustrates an enlarged view of the hinge assembly shown in FIG. 3, in accordance with aspects of the present disclosure.

FIG. 5 illustrates an enlarged alternate view of the hinge assembly shown in FIG. 3, showing additional features of the hinge assembly, in accordance with aspects of the present disclosure.

FIG. 6 illustrates a rear perspective view of a vehicle, showing multiple closures of the vehicle in an open position, in accordance with aspects of the present disclosure.

FIG. 7 illustrates an enlarged view of the hinge assembly shown in FIG. 6, in accordance with aspects of the present disclosure.

FIG. 8 illustrates a perspective view of a hinge assembly, in accordance with aspects of the present disclosure.

FIG. 9 illustrates a partial cross sectional view of a vehicle, showing the connections of the hinge assembly and the strut to the vehicle body, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is generally directed to hinge assemblies that include a hinge component (e.g., leaf) for a first closure (e.g., glass substrate) and a hinge component for a second closure (e.g., liftgate). Each hinge component can move independently of the other, while rotating about the same axis of rotation. Using a single actuating system (e.g., electromechanical struts), the hinge assembly allows for the first closure to open by moving relative to the second closure. Moreover, if the first and second closures are coupled together (e.g., by a latch(es)), the hinge assembly allows both the first and second closures to open and simultaneously using the actuating system. Also, the location of the hinge assemblies and the struts are positioned to balance the center of gravity for each of the first and second closures, as well as a combined center of gravity of both of the first and second closures. Beneficially, additional actuating systems (e.g., torsion springs) may not be required.

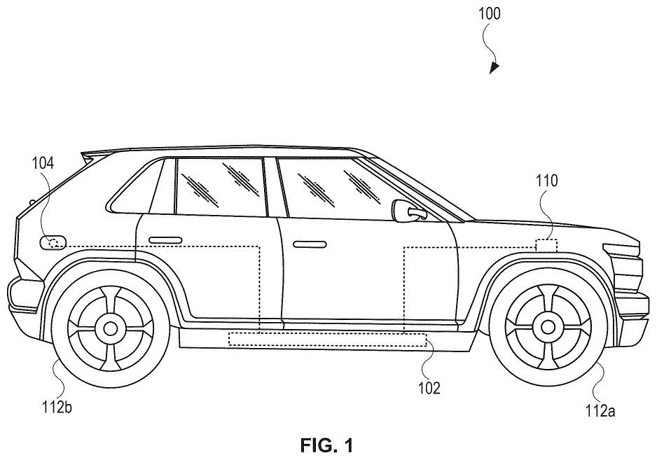

FIG. 1 illustrates an example of a vehicle 100, in accordance with aspects of the present disclosure. In the example shown in FIG. 1, the vehicle 100 is a sport utility vehicle (SUV). Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be coupled (e.g., electrically coupled) to one or more electrical systems of the vehicle 100 to provide power to the one or more electrical systems. The vehicle 100 may further include a port 104 (e.g., charge port) designed to receive a cable connector (not shown in FIG. 1) used to transmit power (e.g., alternating current (AC) power) that is converted to direct current (DC) power to charge the battery pack 102. The battery pack 102 may couple to a drive unit 110, representative of one or more drive units of the vehicle 100. While the drive unit 110 is shown as generally being in the front of the vehicle 100, the drive unit 110 may located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) the wheels of the vehicle 100.

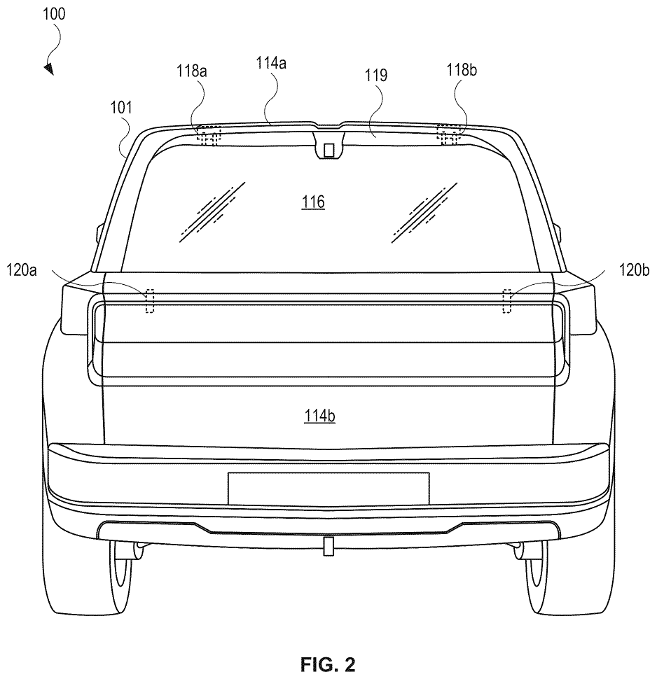

FIG. 2 illustrates a rear view of the vehicle 100, in accordance with aspects of the present disclosure. As shown, the vehicle 100 may include a closure 114a and a closure 114b. The closures 114a and 114b are designed to open to allow access to the vehicle 100, and also close to allow the vehicle 100 to enclosure and carry various objects. In one or more implementations, the closure 114a includes a transparent substrate 116 (e.g., glass substrate). However, the transparent substrate 116 may be substituted with an opaque or translucent substrate. In one more implementations, the closure 114b takes the form of a liftgate. Based on their locations, each of the closure 114a and the closure 114b may be referred to as a rear closure.

As shown in FIG. 2, each of the closures 114a and 114b is in a closed position. In order to open and/or close the closures 114a and 114b, the vehicle 100 may include a hinge assembly 118a and a hinge assembly 118b. Each of the hinge assembly 118a and the hinge assembly 118b may be coupled, or connected, to the closures 114a and 114b. The vehicle 100 includes a vehicle body 101, and the hinge assembly 118a and the hinge assembly 118b are coupled with the vehicle body 101. Further, the hinge assembly 118a and the hinge assembly 118b may couple the closures 114a and 114b with the vehicle body 101. The vehicle 100 may further include a latch 120a and a latch 120b. The latches 120a and 120b are designed to couple the closures 114a and 114b, and may further decouple, release, the closure 114a and from the closure 114b. In this regard, each of the latches 120a and 120b may include a bolt that is movable into the closure 114b (e.g., to couple the closures 114a and 114b together) and movable out of the closure 114b (e.g., to decouple the closures 114a and 114b). While the latches 120a and 120b are disposed in the closure 114a, in other implementations, the latches 120a and 120b are disposed in the closure 114b.

The closure 114a may move to an open position relative to, or independently from, the closure 114b when the latches 120a and 120b are not coupling the closure 114a with the closure 114b. The hinge assembly 118a and the hinge assembly 118b may facilitate the relative movement of the closure 114a with respect to the closure 114b. When the latches 120a and 120b function to couple the closures 114a and 114b together, both the closure 114a and the closure 114b may move to an open position. The hinge assembly 118a and the hinge assembly 118b may facilitate the movement of both of the closure 114a and the closure 114b. The vehicle 100 may further include a spoiler 119 that hides, or at least partially obscures, the hinge assembly 118a and the hinge assembly 118b from view.

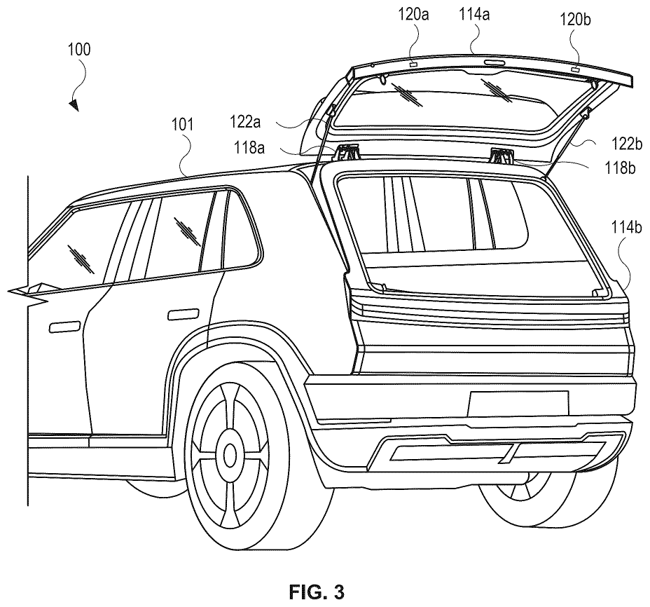

FIG. 3 illustrates a rear perspective view of the vehicle 100, showing a closure 114a of the vehicle 100 in an open position, in accordance with aspects of the present disclosure. Each of the hinge assembly 118a and the hinge assembly 118b may facilitate movement of the closure 114a, including movement of the closure 114a relative to the closure 114b. As shown, the latches 120a and 120b not coupling the closure 114a with the closure 114b. In order to actuate the latches 120a and 120b to cause a coupling or decoupling between the closure 114a with the closure 114b, the vehicle 100 may include a button (not shown in FIG. 3) that may be depressed by a user to initiate the latches 120a and 120b to couple or decouple the closures 114a and 114b. The button may take the form physical button or a virtual button on a display (e.g., a display in the vehicle 100 or a display on a smartphone). Based on the closure 114a in the open position, users may load cargo into the vehicle 100.

In order to move the closure 114a, the vehicle 100 may further include a strut 122a and a strut 122b. In one or more implementations, each of the struts 122a and 122b takes the form of an electromechanical strut controlled by, for example, power from the battery pack 102 (shown in FIG. 1). In this regard, the struts 122a and 122b may include power struts that provide a force (e.g., applied force) to move/lift the closure 114a. Each of the struts 122a and 122b may be coupled (e.g., at one respective end) to the vehicle body 101 and also coupled (e.g., at another opposite end) to the closure 114a. Accordingly, actuation of the struts 122a and 122b may cause the closure 114a to open and close.

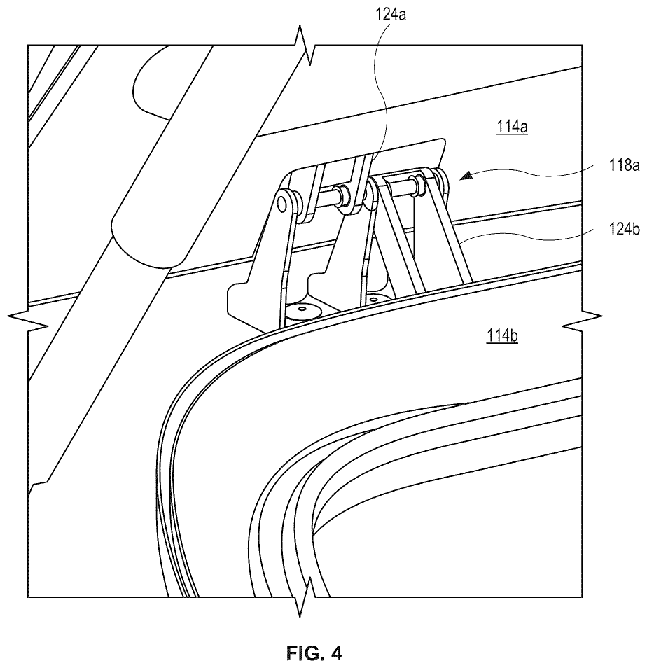

FIG. 4 illustrates an enlarged view of the hinge assembly 118a shown in FIG. 3, in accordance with aspects of the present disclosure. The components and associated features of the hinge assembly 118a may be present in the hinge assembly 118b (shown in FIG. 3). The hinge assembly 118a may include a hinge component 124a (e.g., leaf, arm) coupled with the closure 114a. The hinge assembly 118a may further include a hinge component 124b coupled with the closure 114b. The hinge component 124a may facilitate movement of the closure 114a. In this regard, during movement of the closure 114a relative to the closure 114b, the hinge component 124a may move relative to the hinge component 124b.

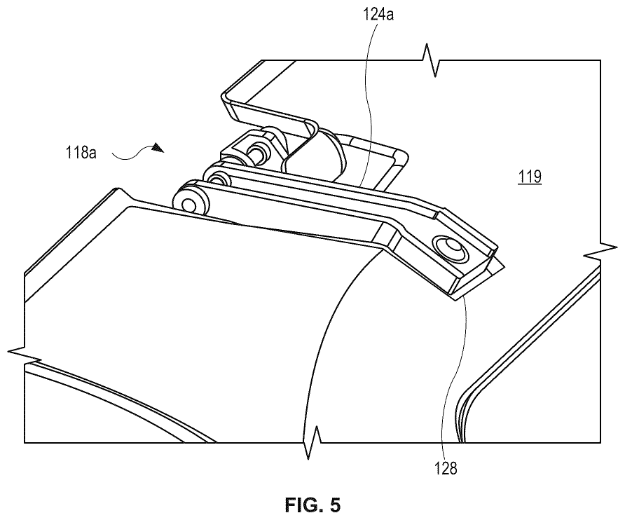

FIG. 5 illustrates an enlarged alternate view of the hinge assembly 118a shown in FIG. 3, showing additional features of the hinge assembly 118a, in accordance with aspects of the present disclosure. For purposes of illustration, a portion of the spoiler 119 is removed. The hinge component 124a of the hinge assembly 118a may be shaped to conform to the shape of the spoiler 119. Additionally, the spoiler 119 may include a groove 128 to receive the hinge component 124a.

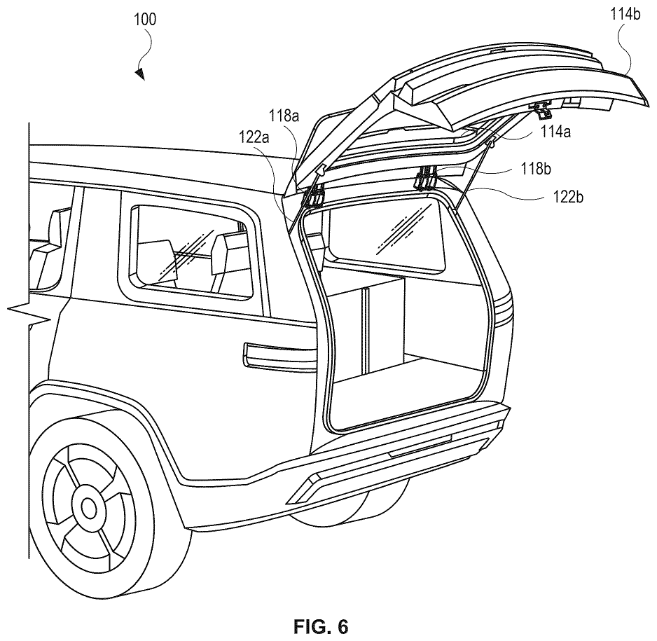

FIG. 6 illustrates a rear perspective view of the vehicle 100, showing multiple closures of the vehicle 100 in an open position, in accordance with aspects of the present disclosure. As shown, each of the closures 114a and 114b is in the open position, thus providing additional access for users to the rear of the vehicle 100. Each of the hinge assembly 118a and the hinge assembly 118b may facilitate movement of the closure 114a and the closure 114b. Each of the latches 120a and 120b (shown in FIG. 3) may couple the closure 114a and 114b. When the latches 120a and 120b couple the closure 114a with the closure 114b, the actuation of the struts 122a and 122b cause both the closure 114a and the closure 114b to transition to the open position, as shown in FIG. 6. Further, the hinge assembly 118a and the hinge assembly 118b may facilitate movement of both the closure 114a and the closure 114b, including simultaneous movement of the closure 114a and the closure 114b. Accordingly, the hinge component 124a (shown in FIG. 4) may rotate the closure 114a about an axis of rotation (shown below) while the hinge component 124b rotates the closure 114b about the same axis of rotation. It should be noted that the closures 114a and 114b may return to the closed position shown in FIG. 3.

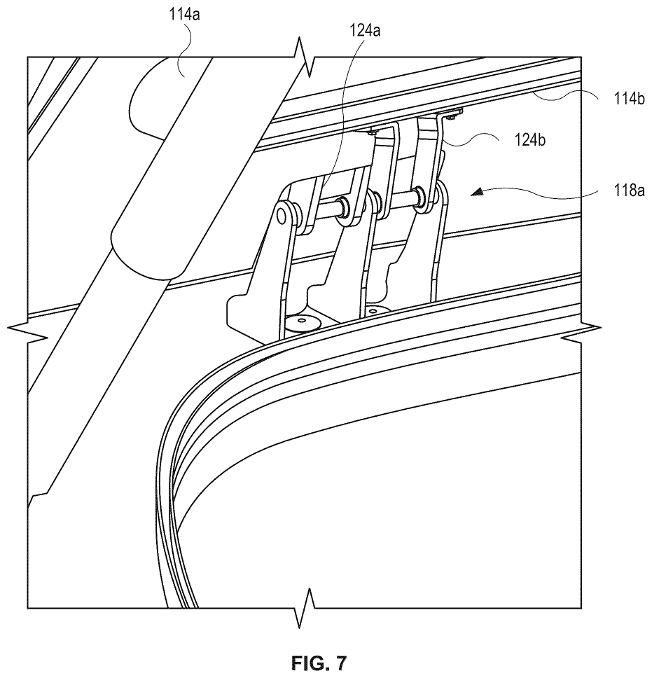

FIG. 7 illustrates an enlarged view of the hinge assembly 118a shown in FIG. 6, in accordance with aspects of the present disclosure. The hinge component 124a and the hinge component 124b may facilitate movement (e.g., rotational movement) of the closure 114a and the closure 114b, respectively. Further, each of the hinge components 124a and 124b may move independently while being coupled with their respective closures.

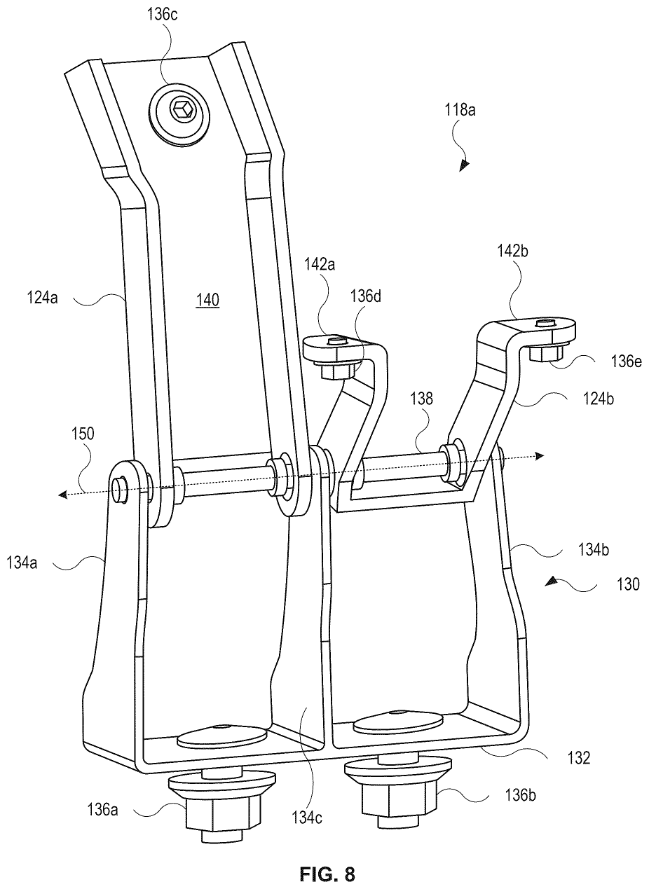

FIG. 8 illustrates a perspective view of the hinge assembly 118a, in accordance with aspects of the present disclosure. The components and associated features of the hinge assembly 118a may be present on the hinge assembly 118b (e.g., shown in FIG. 3). The hinge assembly 118a may include a base 130. The base 130 may include a platform 132. The base 130 may further include several extensions that extend from the platform 132. For example, the base 130 may include an extension 134a, an extension 134b, and an extension 134c. In one or more implementations, each of the extensions 134a, 134b, and 134c extends perpendicularly from the platform 132. Also, as shown, the extension 134c is positioned between the extension 134a and the extension 134b. Further, the hinge component 124a is positioned, or at least partially positioned, between the extension 134a and the extension 134c, and the hinge component 124b is positioned, or at least partially positioned, between the extension 134b and the extension 134c. The base 130 may further include openings (not shown) to receive a bolt 136a and a bolt 136b through the platform 132. The bolts 136a and 136b may couple the hinge assembly 118a, and in particular the base 130, to the vehicle body 101 (shown in FIG. 2).

The hinge assembly 118a may further include a bar 138 that functions to couple the hinge component 124a and the hinge component 124b with the base 130. As non-limiting examples, the bar 138 may take the form of a bolt, a pin, a dowel, or cylindrical body. The bar 138 may pass through respective openings of the hinge components 124a and 124b, as well as through respective openings of the extensions 134a, 134b, and 134c. As shown, the bar 138 is configured to couple the hinge component 124a and the hinge component 124b with the base 130. The bar 138 may allow rotation of the hinge component 124a and the hinge component 124b. In this regard, the bar 138 may define an axis of rotation 150 for the hinge component 124a and the hinge component 124b. Accordingly, the hinge components 124a and 124b may share the same axis of rotation (e.g., the axis of rotation 150). In one or more implementations, the hinge assembly 118a include multiple bars (e.g., two cylindrical bodies that replace the bar 138 (a singular cylindrical body)).

In order to couple with their respective closures, the hinge component 124a and the hinge component 124b may include different sizes and shapes. For example, the hinge component 124a may include a generally rectangular body with a surface 140 that is planar, or flat, or at least partially planar. As shown, hinge component 124a may further include an opening (not shown) to receive a bolt 136c through the surface 140. The bolt 136c may couple the hinge assembly 118a, and in particular the hinge component 124a, to the closure 114a (shown in FIG. 2). Conversely, the hinge component 124b may include an arm 142a and an arm 142b. As shown, each of the arms 142a and 142b is flanged. Further, each of the arm 142a and the arm 142b may include an opening (not shown) to receive a bolt 136d and a bolt 136e through a respective flanged portion of the arm 142a and the arm 142b. The bolts 136d and 136e may couple the hinge assembly 118a, and in particular the hinge component 124b, to the closure 114b (shown in FIG. 2).

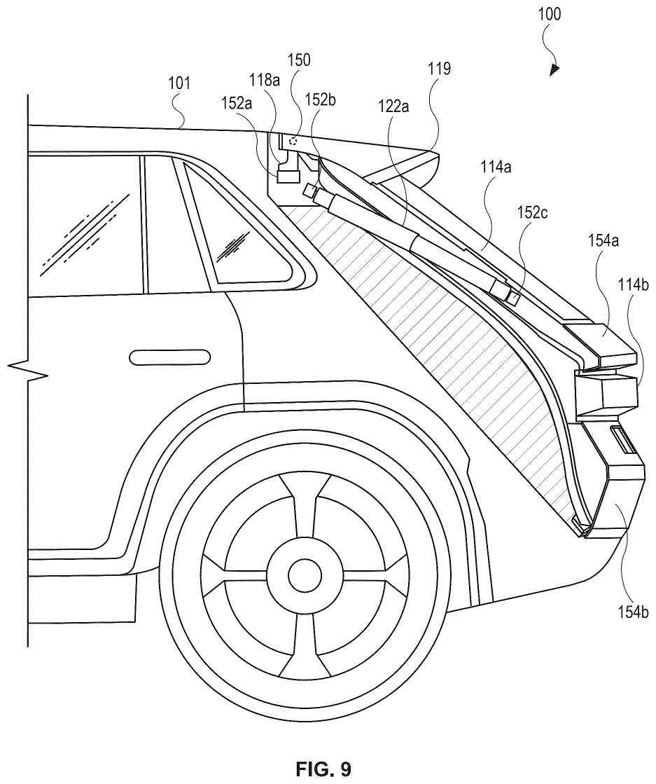

FIG. 9 illustrates a partial cross sectional view of the vehicle 100, showing the connections of the hinge assembly 118a and the strut 122a to the vehicle body 101, in accordance with aspects of the present disclosure. The components and associated features of the hinge assembly 118a and the strut 122a may be applicable to the hinge assembly 118b and the strut 122b, respectively (shown in FIG. 3). The hinge assembly 118a, including the bar 138 (shown in FIG. 8), may define the axis of rotation 150 about which the closure 114a and the closure 114b rotate.

As shown, the strut 122a is further coupled with the closure 114a. The hinge assembly 118a is coupled with the vehicle body 101 at a connection point 152a. Also, between an end the strut 122a is coupled with the vehicle body 101 at a connection point 152b. Further, another, opposite end of the strut 122a is coupled with the closure 114a at a connection point 152c. The respective connection points between components may be chosen based in part on the closures 114a and 114b. For example, given a center of gravity 154a and a center of gravity 154b of a mass (e.g., the closure 114a) and a mass (e.g., the closure 114b), respectively, the aforementioned connection points of the hinge assembly 118a and the strut 122a are selected to balance the center of gravity 154a and the center of gravity 154b. In this regard, the length of the strut 122a is selected in order to position the connection points between the strut 122a and the vehicle body 101 and between the strut 122a and the closure 114a, which in turn functions in part to balance the center of gravity 154a and the center of gravity 154b. Moreover, the relative position between the hinge assembly 118a and the strut 122a is also selected to balance the center of gravity 154a and the center of gravity 154b.

Also, by selecting the aforementioned connection points, the vehicle 100 may not require other mechanisms (torsions springs) to provide a lift force to move the closures 114a, as the hinge assembly 118a and the strut 122a (as well as the hinge assembly 118b and the strut 122b, shown in FIG. 6) may provide the required force and/or direction to not only open and close the closure 114a (e.g., the mass of the closure 114a) relative to the closure 114b but to also open and close both of the closures 114a and 114b (e.g., the combined mass of each of the closures 114a and 114b). Beneficially, the cost and weight of the vehicle 100 may be lower due in part to fewer actuation components needed, and the complexity of opening and closing the closures 114a and 114b may also be reduced.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. An apparatus, comprising:
a hinge assembly, comprising:
a first hinge component configured to couple with a first rear closure of a vehicle and rotate the first rear closure about an axis of rotation; and
a second hinge component configured to couple with a second rear closure of the vehicle and rotate the second rear closure about the axis of rotation.

2. The apparatus of claim 1, wherein:
the hinge assembly further comprises a base configured to couple with the vehicle,
the first hinge component is configured to couple with the base, the first hinge component configured to rotate the first rear closure about the axis of rotation, and
the second hinge component is configured to couple with the base, the second hinge component configured to rotate the second rear closure about the axis of rotation.

3. The apparatus of claim 2, wherein:
the first hinge component is configured to rotate independently of the second hinge component, and
the second hinge component is configured to rotate independently of the first hinge component.

4. The apparatus of claim 2, wherein the hinge assembly further comprises a bar rotationally coupled with the base, the bar configured to pass through the first hinge component and the second hinge component.

5. The apparatus of claim 4, wherein the bar defines the axis of rotation.

6. The apparatus of claim 1, further comprising a latch configured to couple the first rear closure with the second rear closure, wherein in response to the latch coupling the first rear closure with the second rear closure, the first hinge component is configured to rotate the first rear closure about the axis of rotation while the second hinge component rotates the second rear closure about the axis of rotation.

7. The apparatus of claim 6, wherein in response to the latch not coupling the first rear closure with the second rear closure, the hinge assembly is configured to rotate the first rear closure, relative to the second rear closure, about the axis of rotation.

8. The apparatus of claim 1, further comprising a strut coupled with the first rear closure, wherein the strut is configured to provide a force to rotate the first rear closure about the axis of rotation.

9. The apparatus of claim 8, wherein the strut is further configured to provide the force to rotate the second rear closure about the axis of rotation.

10. An apparatus, comprising:
a hinge assembly configured to couple with a vehicle body, the hinge assembly comprising:
a first hinge component coupled with a first rear closure, and
a second hinge component coupled with a second rear closure; and
a latch, wherein in response to the latch coupling the first rear closure with the second rear closure, i) the first hinge component is configured to rotate the first rear closure about an axis of rotation and ii) the second hinge component is configured to rotate the second rear closure about the axis of rotation.

11. The apparatus of claim 10, wherein in response to the latch not coupling the first rear closure with the second rear closure, the first hinge component is configured to rotate the first rear closure about the axis of rotation relative to the second rear closure.

12. The apparatus of claim 10, wherein:
the hinge assembly further comprises a base coupled with the vehicle body,
the first hinge component is configured to couple with the base, the first hinge component configured to rotate the first rear closure about the axis of rotation, and
the second hinge component is configured to couple with the base, the second hinge component configured to rotate the second rear closure about the axis of rotation.

13. The apparatus of claim 12, wherein:
the first hinge component is configured to rotate independently of the second hinge component, and
the second hinge component is configured to rotate independently of the first hinge component.

14. The apparatus of claim 12, wherein:
the hinge assembly further comprises a bar rotationally coupled with the base, and
the bar passes through the first hinge component and the second hinge component.

15. The apparatus of claim 14, wherein the bar defines the axis of rotation.

16. The apparatus of claim 10, wherein the second flange component comprises:
a first flanged arm, and
a second flanged arm.

17. The vehicle apparatus of claim 10, further comprising:
a first extension; and
a second extension;
a third extension positioned between the first extension and the second extension; and
a bar passing through the first extension, the second extension, the third extension, the first hinge component, and the second hinge component.

18. The apparatus of claim 16, wherein the hinge assembly, along with a strut, are configured to balance i) a first mass defined by the first rear closure and ii) a second mass defined by the first rear closure and the second rear closure.

19. A hinge assembly, comprising:
a base comprising:
a first extension,
a second extension, and
a third extension positioned between the first extension and the second extension;
a first hinge component positioned between the first extension and the third extension, the first hinge component configured to couple with a first rear closure of a vehicle about an axis of rotation; and
a second hinge component positioned between the second extension and the third extension, the second hinge component configured to couple with a second rear closure of the vehicle about the axis of rotation; and
a bar coupled with the base and passing through the first hinge component and the second hinge component.

20. The hinge assembly of claim 19, wherein:
the first hinge component is configured to rotate independently of the second hinge component, and
the second hinge component is configured to rotate independently of the first hinge component.
